(19) United States
(12) Patent Application Publication
(10) Pub. No.: US 2023/0026437 A1
(43) Pub. Date: Jan. 26, 2023

(54) BACTERIA-ASSOCIATED VOLATILE ORGANIC COMPOUNDS

(71) Applicants: THE STATE OF ISRAEL, MINISTRY OF AGRICULTURE & RURAL DEVELOPMENT, AGRICULTURAL RESEARCH ORGANIZATION, Rishon Lezion (IL); Ramot at Tel-Aviv University Ltd., Tel Aviv (IL)

(72) Inventors: Dror MINZ, Nes Zionna (IL); Shmuel Haim CARMELI, Tel Aviv (IL); Anuj RANA, Hisar (IL); Bogdan BELGORODSKY, Tel Aviv (IL); Rakeshkumar Manojkumar JAIN, Jalgaon (IN); Eddie Joseph CYTRYN, Modiin (IL)

(73) Assignees: THE STATE OF ISRAEL, MINISTRY OF AGRICULTURE & RURAL DEVELOPMENT, AGRICULTURAL RESEARCH ORGANIZATION, Rishon Lezion (IL); Ramot at Tel-Aviv University Ltd., Tel Aviv (IL)

(21) Appl. No.: 17/783,276

(22) PCT Filed: Dec. 8, 2020
(86) PCT No.: PCT/IL2020/051263

§ 371 Date: Jun. 8, 2022

Related U.S. Application Data
(60) Provisional application No. 62/945,181, filed on Dec. 8, 2019.

(51) Int. Cl. A01N 63/22; A01N 37/10; A01N 35/02; A01N 31/02; A01P 3/00; A01P 5/00; A01P 1/00

(52) U.S. Cl. CPC A01N 63/22; A01N 37/10; A01N 35/02; A01N 31/02; A01P 3/00; A01P 5/00; A01P 1/00

(57) ABSTRACT

The present disclosure relates to bacteria and bacteria-associated volatile organic compounds, and to their use in agriculture.

### BACKGROUND OF THE DISCLOSURE

Bacteria found in the rhizosphere, a layer of soil which is influenced by root secretions and associated soil microorganisms, and especially volatile organic compounds derived therefrom, play an important role in terrestrial ecosystem. There are several microbes in nature which produce a mixture of volatile organic compounds (VOCs) but only few bacteria are unique in that that they produce volatile organic compounds during the intermediate metabolic pathways from early log phase to late exponential phase during their life cycle. These compounds have low molecular mass, low solubility in water, diffuse uniformly in air pockets inside soil, and thus make an impact on microbial community through long distance signaling.

Bacterial-emitted volatiles compounds can diffuse in soil air pocket and spread to farther distances compared to the soluble compounds. These VOCs could have negative or positive effect on growth of many microbes, seed germination, plant immunity and plant growth through independent mechanism. Several VOCs were previously tested for their effect on plants growth and majority of them were found to have negative effects by stunting the plant growth, chlorosis and senescence. Another effect of VOCs was found to be activating plants' defense-related genes.

Microbes are reported to control plant pathogens for several decades, but the role of individual volatile organic compound to control the plant pathogens is not well described. Microbial derived VOCs could be used for biological control of several fungal diseases of plant and foods. There are few inventions on bacterial volatiles to control plant disease by suppressing fungal growth. Similarly, the lethal effect of volatile organic compound on phytopathogens has been reported. The inhibitory effect of volatile compounds on fungal growth and ascospore germination were also reported by several researchers. The role of bacterial volatiles to induce systemic resistance in plant has been reported in few studies. There are reports on the effects of mixture of volatiles to inhibit the growth the plant pathogens by several bacterial species: Pseudomonas fluorescence against Botrytis cinerea, Bacillus amyloliquefaciens against Monilinia laxa, M. fructicola and Botrytis cinera. Many Bacillus spp. were screened for their role to control the fungal disease of fruits and vegetables. Antagonistic effect of Bacillus subtilis were reported against Botrytis cinerea to inhibit spore germination and elongation. An unknown mixture of volatile compounds produced by Bacillus subtilis showed antagonism against Rhizoctonia solani. Volatile organic compounds Benzaldehyde, 1,2-benzisothiazol-3(2H)-one and 1,3-butadiene produced by Bacillus sp. showed antagonistic effect against Ralstonia solanacearum by inhibiting colony growth, cell viability and motility.

Plant-growth-promoting bacteria have been reported to influence plant growth and control plant pathogens through inoculation in soil and spray on plants, but the relevance of gases emitted by these microbes was not explored. Some plant-growth-promoting rhizobacteria (PGPR) like Bacillus spp. have been reported to induce plant growth by emitting mixture of volatiles. Similarly, some fungus like Trichoderma activate defense genes in plants without any direct contact through production of different volatile compounds. Bacterial species like Pseudomonas had been reported to control fungal growth in cowpea through production of volatiles organic compounds against Phytophthora vignae. Yeast volatiles have also been reported to control the growth of diversity of plant pathogenic fungi like Colletotricum acutatum, Botrytis cinerea and Peniicillium expansum. There are few studies which showed the positive impact of bacterial volatiles on plant health but also plant disease. The role of mixture of volatiles to control plant pathogens have been reported by several groups, while the individual effect of volatile organic compounds was not explored well.

Study and characterization of individual volatile organic compounds which are responsible for killing plant pathogens and/or promote plant growth is needed to provide new arsenal for, e.g., supporting commercial plant production.

### SUMMARY OF THE DISCLOSURE

The disclosure provided herein demonstrates the biological activity of 5 volatile organic compounds: Butanoic acid, 2-methyl (herein referred to as “C1”), 5-Methyl-2-hexanone (herein referred to as “C2”), 2,3-Hexanedione (herein referred to as “C3”), 1-Hexanol, 2-ethyl (herein referred to as “C7”) and Methyl-2-heptanone (herein referred to as “C10”), alone and in combination, from a newly-isolated rhizosphere bacteria Bacillus halotolerans herein referred to as “NYG5”.

The present disclosure provides, in one aspect, a composition comprising at least two different volatile organic compounds selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10).

In certain embodiments, the composition comprises C3 and at least one different volatile organic compound selected from the group consisting of C1, C2, C7 and C10. In certain embodiments, the composition comprises C1, C2, C3, C7 and C10.

In certain embodiments, the molar ratio between C1:C2:C3:C7:C10 is 5:17:9:40:29, respectively. In certain embodiments, the weight ratio between C1:C2:C3:C7:C10 is 17:19:19:22:22, respectively.

In certain embodiments, the composition comprises 0.05 ppm to 0.5 ppm of C1, 100 to 500 ppm of C2, 0.01 ppm to 0.5 ppm of C3, 0.05 ppm to 0.5 ppm of C7, or 0.05 ppm to 0.5 ppm of C10. In certain embodiments, the composition comprises 0.05 ppm to 0.5 ppm of C1, 100 to 500 ppm of C2, 0.01 ppm to 0.5 ppm of C3, 0.05 ppm to 0.5 ppm of C7, and 0.05 ppm to 0.5 ppm of C10.

In certain embodiments, the composition further comprises rhizosphere bacteria Bacillus halotolerans NYG5 isolate.

The present disclosure provides, in another aspect, a composition comprising rhizosphere bacteria Bacillus halotolerans NYG5 isolate.

In certain embodiments, the composition further comprises at least one volatile organic compound selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10).

In certain embodiments, the composition comprises C3 and at least one different volatile organic compound selected from the group consisting of C1, C2, C7 and C10. In certain embodiments, the composition comprises C1, C2, C3, C7 and C10.

In certain embodiments, the molar ratio between C1:C2:C3:C7:C10 is 5:17:9:40:29, respectively. In certain embodiments, the weight ratio between C1:C2:C3:C7:C10 is 17:19:19:22:22, respectively.

In certain embodiments, the composition comprises 0.05 ppm to 0.5 ppm of C1, 100 to 500 ppm of C2, 0.01 ppm to 0.5 ppm of C3, 0.05 ppm to 0.5 ppm of C7, or 0.05 ppm to 0.5 ppm of C10. In certain embodiments, the composition comprises 0.05 ppm to 0.5 ppm of C1, 100 to 500 ppm of C2, 0.01 ppm to 0.5 ppm of C3, 0.05 ppm to 0.5 ppm of C7, and 0.05 ppm to 0.5 ppm of C10.

In certain embodiments, the composition further comprises an antifungal agent. In certain embodiments, the composition further comprises an antibacterial agent. In certain embodiments, the composition further comprises a nematicidal agent. In certain embodiments, the composition further comprises a fertilizer.

The present disclosure provides, in another aspect, a method for preventing or treating a disease of a plant, or for improving the growth of a plant, comprising the step of applying a composition comprising rhizosphere bacteria Bacillus halotolerans NYG5 isolate or at least one volatile organic compound selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10), to the plant.

In certain embodiments, the composition comprises at least two different volatile organic compounds selected from the group consisting of C1, C2, C3, C7 and C10. In certain embodiments, the composition comprises C3 and at least one different volatile organic compound selected from the group consisting of C1, C2, C7 and C10. In certain embodiments, the composition comprises C1, C2, C3, C7 and C10.

In certain embodiments, the molar ratio between C1:C2:C3:C7:C10 is 5:17:9:40:29, respectively. In certain embodiments, the weight ratio between C1:C2:C3:C7:C10 is 17:19:19:22:22, respectively.

In certain embodiments, the composition comprises rhizosphere bacteria Bacillus halotolerans NYG5 isolate and at least one volatile organic compound selected from the group consisting of C1, C2, C3, C7 and C10.

In certain embodiments, the method comprises the step of applying the composition to the root, stem or leaves of the plant. In certain embodiments, the method comprises the step of applying the composition to the entire plant.

In certain embodiments, the infection is a fungal infection. In certain embodiments, the fungus is of a Division selected from the group consisting of Ascomycota, Oomycota, and Basidiomycota. In certain embodiments, the fungus is of a Class selected from the group consisting of Leotiomycetes, Oomycetes, Dothideomycetes, Agaricomycetes, and Sordariomycetes. In certain embodiments, the fungus is of an Order selected from the group consisting of Helotiales, Pythiales, Botryosphaeriales, Cantharellales, and Hypocreales. In certain embodiments, the fungus is of a Family selected from the group consisting of Sclerotiniaceae, Pythiaceae, Botryosphaeriaceae, Ceratobasidiaceae, and Nectriaceae.

In certain embodiments, the method further comprises the step of applying another antifungal agent to the plant.

In certain embodiments, the infection is a bacterial infection. In certain embodiments, the method further comprises the step of applying another antibacterial agent to the plant.

In certain embodiments, the infection is a nematode infection. In certain embodiments, the method further comprises the step of applying another nematicidal agent to the plant.

In certain embodiments, the plant is selected from the group consisting of vegetables, fruits, cereals, herbs, plant seeds, plant leaves, plant tubers, and ornamental plants.

In certain embodiments, the composition is applied to the plant before the plant is harvested. In certain embodiments, the composition is applied to the plant after the plant is harvested.

The present disclosure provides, in another aspect, a transgenic cell, which produces at least one volatile organic compound selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10).

In certain embodiments, the transgenic cell produces at least two different volatile organic compounds selected from the group consisting of C1, C2, C3, C7 and C10. In certain embodiments, the transgenic cell produces C3 and at least one different volatile organic compound selected from the group consisting of C1, C2, C7 and C10. In certain embodiments, the transgenic cell produces C1, C2, C3, C7 and C10.

In certain embodiments, the transgenic cell is a bacteria cell.

The present disclosure provides, in another aspect, a plant, or any part thereof, at least partly in contact with rhizosphere bacteria Bacillus halotolerans NYG5 isolate or with at least one volatile organic compound selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10).

The present disclosure provides, in another aspect, a method of fumigating a growing medium for plants, comprising applying a composition comprising rhizosphere bacteria Bacillus halotolerans NYG5 isolate or at least one volatile organic compound selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10), to the growing medium.

The present disclosure provides, in another aspect, a growing medium for plants, at least partly in contact with rhizosphere bacteria Bacillus halotolerans NYG5 isolate or with at least one volatile organic compound selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10).

The present disclosure provides, in another aspect, a dispenser, comprising a container comprising rhizosphere bacteria Bacillus halotolerans NYG5 isolate or at least one volatile organic compound selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10).

### BRIEF DESCRIPTION OF THE DRAWINGS

FIG. 1A-FIG. 1F. Effect of NYG5-derived volatiles growth inhibition of phytopathogens in a two-compartment plate assay. FIG. 1A) Sclerotinia sclerotiorum growth in control plate; FIG. 1B) No mycelium growth after volatile exposure; FIG. 1C) Leuconstoc mesenteroides colonies growth in control plate; FIG. 1D) L. mesenteroides colony growth was inhibited after volatile exposure; FIG. 1E) Sclerotia (a compact mass of fungal mycelium of Sclerotinia sclerotiorum, resistant to extreme environmental conditions like heat and drought) germination in control plate; FIG. 1F) Inhibition of sclerotia germination in presence of NYG5-produced mixture of volatiles.

FIG. 2A-FIG. 2B. Effects of NYG5-derived volatiles on mycelial growth inhibition and sclerotia germination. FIG. 2A) Percent growth inhibition of fungal mycelium (Macrophomina phaseolina, Rhizoctonia solani, Pythium aphanidermatum, Sclerotinia sclerotiorum) and bacterial pathogen (L. mesenteroides);

FIG. 2B) Exposure of volatiles showed lethal effect on sclerotia germination. Bars represent the mean value of 25 sclerotia and error bars are the means of standard deviation, n=5. DPT=Days post treatment.

FIG. 3A-FIG. 3F. GCMS Chromatographic profile of NYG5-produced volatile organic compounds with pure standard compounds. Each chromatogram shows the representative peak of the NYG5-produced volatile relative to pure standard in the upper half portion and mass fractionation in lower half respectively. FIG. 3A) C1—Butanoic acid, 2-methyl; FIG. 3B) C2—5-Methyl-2-hexanone; FIG. 3C) C3—2,3-Hexanedione; FIG. 3D) C7 1-Hexanol, -2-ethyl; FIG. 3E) C10—Methyl-2-heptanone; FIG. 3F) C3—detection on nitrate minimal growth medium. “S” represents the peak of pure standard of the relative compound.

FIG. 4A-FIG. 4E. In-vitro antifungal activity of pure volatile organic compounds. Bar represents the mean value of mycelium growth inhibition (%) against fungal pathogens Macrophomina phaseolina, Rhizoctonia solani, Pythium aphanidermatum, Sclerotinia sclerotiorum after time interval with different concentrations of synthetic compounds. FIG. 4A) C1—Butanoic acid, 2-methyl; FIG. 4B) C2—5-Methyl-2-hexanone; FIG. 4C) C3—2,3-Hexanedione; FIG. 4D) C7—1-Hexanol, -2-ethyl; FIG. 4E) C10—Methyl-2-heptanone. Error bars are the means of standard deviation, n=3.

FIG. 5A-FIG. 5F. Effect of C3 on Fusarium oxysporum f sp. cucumerinum spore viability in liquid. Microscopic view of C3 (2,3-Hexanedione) treated spore germination. FIG. 5A) C3 treated spore lose viability and no spore germination was observed; FIG. 5B) Germination tube elongation in untreated spores. In petri plates treated spores did not show any growth (FIG. 5C, FIG. 5D, FIG. 5E), while untreated spores (control) grow well on PDA plate (FIG. 5F).

FIG. 6A-FIG. 6D. Effect of C3 exposure on actively growing Macrophomina phaseolina. FIG. 6A) Mycelium growth (black pigmentation) in control PDA plate; FIG. 6B) Mycelium growth inhibition and discoloration after C3 exposure. FIG. 6C-FIG. 6D) Microscopic observation of lacto-phenol cotton blue stained mycelium. FIG. 6C) long filament of mycelium in control plate; FIG. 6D) C3 exposed mycelium showed stunted growth and protoplasm retraction as pointed by arrows in the Figure.

FIG. 7A-FIG. 7C. Effect of C3 on M. javanica viability. M. javanica were exposed for 2 days to C3 compound (0.05 and 0.5 ppm) and NYG5 in a two-compartment plate. FIG. 7A) bent shape of nematodes represents motility and survivability; FIG. 7B) C3 volatile exposure has nematicidal effect and become linear shape after death; FIG. 7C) shows the number of viable M. javanica after VOC exposure.

FIG. 8A-FIG. 8C. Effect of C3 on Arabidopsis thaliana growth. Germinated seedlings of A. thaliana were placed on MS gar medium in a two-compartment plate with sterile disc on the second half of the plate. In treatments C3 was placed on disc and control leaves blank. Visible view of A. thaliana growth after 2 weeks of C3 exposure in two compartment plates. FIG. 8A) Control plants looks smaller and shorter; FIG. 8B) C3 exposed plants enhance growth with wider leaf and long shoot length; FIG. 8C) Individual effect of different concentrations (0.005, 0.05 and 0.5 ppm) of C3 to increase plant biomass in terms of shoot and root weight.

FIG. 9. In-vitro transcriptional expression of pathogenesis-related (PR) genes of Arabidopsis thaliana. Leaves of A. thaliana plants were used to quantify relative gene expression of C3 exposed plants with control plants after 7 days exposure. qPCR was performed to quantify the gene expression level of PR1, PR2, PR5 gene transcripts.

FIG. 10A-FIG. 10B. The Effect of NYG5 (Minimal Media+1% Galactose) on Cucumis sativus Growth. FIG. 10A) Root length, weight; FIG. 10B) Visual comparison.

FIG. 11A-FIG. 11B. The Effect of NYG5 on Tobacco Seedlings Growth. FIG. 11A) Root length, weight; FIG. 11B) Visual comparison.

FIG. 12A-FIG. 12B. 2,3-Hexanedione (C3) effect on Nicotiana tabacum cv. Samsun Growth. FIG. 12A) Root length; FIG. 12B) Weight.

### DETAILED DESCRIPTION OF THE DISCLOSURE

The present disclosure exemplifies the ability of bacterial-derived volatile organic compounds to kill phytopathogens, induce plant resistance, and promote plant growth. Five volatile organic compounds were detected by growing bacteria on LB and nitrate minimal medium, identified through GC-MS, and exemplified to possess significant broad-range anti-microbial activity. The experimental results demonstrate that a bacterial strain termed “NYG5” is a rich source of bioactive volatile organic compounds. These compounds can be used to control pathogens in e.g. post-harvest food storage. The volatile bactericides are easy to use for controlling plant diseases, in similarity to the role of SO₂ as control measure of grapes.

Specifically, five volatile organic compounds from NYG5 were identified through GC-MS analysis based on their mass and retention time. The antifungal nature of the compounds was observed against four plant pathogenic fungi in plate assay. The experiments described herein characterize the role of volatile organic compounds as fungicidal, PR genes inducing (see Table 1), plant growth agents. Very low concentrations of these compounds had strong fungicidal effect against all tested pathogens, characterized as non-toxic and found to be safe as food ingredient (Joint FAO/WHO Expert Committee on Food Additives (JECFA)—JECFA number 412).

TABLE 1
Classification of pathogenesis related (PR)-proteins.

| | Size | | |
|---|---|---|---|
| Family | (kDa) | Member | Properties |
| PR-1a | 15 | Tobacco (PR-1a) | Antifungal |
| PR-2 | 30 | Tobacco (PR-2) | β-1,3-glucanases |
| PR-3 | 25-30 | Tobacco P,Q | Chitinases (I, II, IV, V, VI, VII) |
| PR-4 | 15-20 | Tobacco R | Chitinases (I, II) |
| PR-5 | 25 | Tobacco S | Thaumatin-like proteins (TLPs) |
| PR-6 | 8 | Tomato inhibitor I | Proteinase inhibitor |
| PR-7 | 75 | Tomato | Endoproteinase |
| PR-8 | 28 | Cucumber chitinase | Chitinase (III) |
| PR-9 | 35 | Tobacco (lignin-forming | Peroxidase |
| | | peroxidase) | |
| PR-10 | 17 | Parsley (PR-1) | Ribonuclease-like proteins |
| | | | (RLP) |
| PR-11 | 40 | Tobacco class-V chitinase | Chitinase (1) |
| PR-12 | 5 | Radish Rs AFP3 | Defensin |
| PR-13 | 5 | Arabidopsis Thi2.1 | Thionin |
| PR-14 | 9 | Barley LTP4 | Lipid-transfer protein (LTP) |
| PR-15 | 20 | Barley OxOa (germin) | Oxalate oxidase (OXO) |
| PR-16 | 20 | Barley OxOLP | Oxalate oxidase-like (OXO) |
| PR-17 | 27 | Tobacco PRp27 | Antiviral and antifungal |

Among the volatile organic compounds identified, 2,3-Hexanedione, or “C3”, had been chosen as a representative. The effect of C3 was tested on tomato root knot nematode in in-vitro conditions. C3 had shown nematicidal activity on M. javanica larvae in plate assay. The larvae were exposed with C3 volatile without any direct contact. C3 had shown strong nematicidal effect with exposure of 0.5 ppm and killed 80% nematodes after 2 days of exposure. Therefore, C3 compound can be used to control the root knot nematode disease of plants. With comparison to previous reports, C3 showed strong nematicidal and fungicidal effect at lower concentrations and was found to be environmentally safe to use for control plant pathogens.

Most of the bacterial and fungal derived volatile organic compounds have antagonistic activity against plant pathogens, but very few were tested for plant development. The results provided here show that NYG5 bacteria, which produce C3, appear to stimulate plant growth and development in in-vitro conditions. A significant increase was observed in fresh shoot and root weight following exposure of 0.05 ppm of C3 compound in a two-compartment plate experiment. Exposure to C3 enhanced Arabidopsis growth in plate assay without direct contract.

There are few reports for the role of microbial-derived volatiles in induction of plant resistance. It is now demonstrated that C3 triggered both jasmonic acid (JA)- and salicylic acid (SA)-responsive PR1 and PR2 proteins and can be used to initiate plant resistance against pathogens. Additionally, 0.05 ppm C3 had increased the fresh weight of A. thaliana 3-fold and developed plant immunity by induction of PR genes response to pathogen related proteins.

These findings prove the multifarious role of NYG5-derived volatile organic compounds, such as C3, in enhancing plant development, inducing plant resistance related PR genes and proteins, and killing plant pathogens without any direct contact. These PR genes respond to pathogens by inducing resistance by expression of pathogenesis-related proteins in the plant.

These findings provide new insights for the use of such compounds for plant protection by killing plant pathogens and inducing plant resistance and growth. Majority of plant pathogens survive in the soil using plant debris as nutrient and cause root-borne disease in favorable growth conditions, either resulted in yield loss or death of the plant. To prevent such soil-borne pathogens, soil fumigation is required before sowing the valuable crops. Microbial-derived volatiles kill a diversity of soil borne pathogenic fungi. These volatile organic compounds could also be used as alternate of Methyl bromide (an ozone-depleting chemical) or other compounds which had been used as soil fumigant.

The present disclosure provides, in one aspect, a composition comprising at least two different volatile organic compounds selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10).

In certain embodiments, the composition comprises C1 and C2. In certain embodiments, the composition comprises C1 and C3. In certain embodiments, the composition comprises C1 and C7. In certain embodiments, the composition comprises C1 and C10.

In certain embodiments, the composition comprises C2 and C3. In certain embodiments, the composition comprises C2 and C7. In certain embodiments, the composition comprises C2 and C10.

In certain embodiments, the composition comprises C3 and C7. In certain embodiments, the composition comprises C3 and C10.

In certain embodiments, the composition comprises C7 and C10.

In certain embodiments, the composition comprises C1 and at least one different volatile organic compound selected from the group consisting of C2, C3, C7 and C10. In certain embodiments, the composition comprises C2 and at least one different volatile organic compound selected from the group consisting of C1, C3, C7 and C10. In certain embodiments, the composition comprises C3 and at least one different volatile organic compound selected from the group consisting of C1, C2, C7 and C10. In certain embodiments, the composition comprises C7 and at least one different volatile organic compound selected from the group consisting of C1, C2, C2 and C10. In certain embodiments, the composition comprises C10 and at least one different volatile organic compound selected from the group consisting of C1, C2, C3 and C7.

In certain embodiments, the composition comprises C1, C2, C3, C7 and C10.

In certain embodiments, the molar ratio between C1:C2:C3:C7:C10 is 5 or 0:17 or 0:9 or 0:40 or 0:29 or 0, respectively.

In certain embodiments, the molar ratio between C1:C2 is 5:17, respectively. In certain embodiments, the molar ratio between C1:C3 is 5:9, respectively. In certain embodiments, the molar ratio between C1:C7 is 5:40, respectively. In certain embodiments, the molar ratio between C1:C10 is 5:29, respectively.

In certain embodiments, the molar ratio between C2:C3 is 17:9, respectively. In certain embodiments, the molar ratio between C2:C7 is 17:40, respectively. In certain embodiments, the molar ratio between C2:C10 is 17:29, respectively.

In certain embodiments, the molar ratio between C3:C7 is 9:40, respectively. In certain embodiments, the molar ratio between C3:C10 is 9:29, respectively.

In certain embodiments, the molar ratio between C7:C10 is 40:29, respectively.

In certain embodiments, the molar ratio between C1:C2:C3:C7:C10 is 5:17:9:40:29, respectively.

In certain embodiments, the weight ratio between C1:C2:C3:C7:C10 is 17 or 0:19 or 0:19 or 0:22 or 0:22 or 0, respectively.

In certain embodiments, the weight ratio between C1:C2 is 17:19, respectively. In certain embodiments, the weight ratio between C1:C3 is 17:19, respectively. In certain embodiments, the weight ratio between C1:C7 is 17:22, respectively. In certain embodiments, the weight ratio between C1:C10 is 17:22, respectively.

In certain embodiments, the weight ratio between C2:C3 is 19:19, respectively. In certain embodiments, the weight ratio between C2:C7 is 19:22, respectively. In certain embodiments, the weight ratio between C2:C10 is 19:22, respectively.

In certain embodiments, the weight ratio between C3:C7 is 19:22, respectively. In certain embodiments, the weight ratio between C3:C10 is 19:22, respectively.

In certain embodiments, the weight ratio between C7:C10 is 22:22, respectively.

In certain embodiments, the weight ratio between C1:C2:C3:C7:C10 is 17:19:19:22:22, respectively.

In certain embodiments, the composition comprises 0.05 ppm to 0.5 ppm of C1, 100 to 500 ppm of C2, 0.01 ppm to 0.5 ppm of C3, 0.05 ppm to 0.5 ppm of C7, or 0.05 ppm to 0.5 ppm of C10. In certain embodiments, the composition comprises 0.05 ppm to 0.5 ppm of C1. In certain embodiments, the composition comprises 100 to 500 ppm of C2. In certain embodiments, the composition comprises 0.01 ppm to 0.5 ppm of C3. In certain embodiments, the composition comprises 0.05 ppm to 0.5 ppm of C7. In certain embodiments, the composition comprises 0.05 ppm to 0.5 ppm of C10. In certain embodiments, the composition comprises 0.05 ppm to 0.5 ppm of C1, 100 to 500 ppm of C2, 0.01 ppm to 0.5 ppm of C3, 0.05 ppm to 0.5 ppm of C7, and 0.05 ppm to 0.5 ppm of C10.

In certain embodiments, the composition further comprises rhizosphere bacteria Bacillus halotolerans NYG5 isolate.

The present disclosure further provides, in a different aspect, a composition comprising rhizosphere bacteria Bacillus halotolerans NYG5 isolate.

In certain embodiments, the rhizosphere bacteria Bacillus halotolerans NYG5 isolate is isolated from other bacteria. In certain embodiments, the rhizosphere bacteria Bacillus halotolerans NYG5 isolate comprises at least 10% of the total weight of the composition. In certain embodiments, the rhizosphere bacteria Bacillus halotolerans NYG5 isolate comprises at least 20% of the total weight of the composition. In certain embodiments, the rhizosphere bacteria Bacillus halotolerans NYG5 isolate comprises at least 30% of the total weight of the composition. In certain embodiments, the rhizosphere bacteria Bacillus halotolerans NYG5 isolate comprises at least 40% of the total weight of the composition. In certain embodiments, the rhizosphere bacteria Bacillus halotolerans NYG5 isolate comprises at least 50% of the total weight of the composition. In certain embodiments, the rhizosphere bacteria Bacillus halotolerans NYG5 isolate comprises at least 60% of the total weight of the composition. In certain embodiments, the rhizosphere bacteria Bacillus halotolerans NYG5 isolate comprises at least 70% of the total weight of the composition. In certain embodiments, the rhizosphere bacteria Bacillus halotolerans NYG5 isolate comprises at least 80% of the total weight of the composition. In certain embodiments, the rhizosphere bacteria Bacillus halotolerans NYG5 isolate comprises at least 90% of the total weight of the composition. In certain embodiments, the rhizosphere bacteria Bacillus halotolerans NYG5 isolate comprises at least 95% of the total weight of the composition. In certain embodiments, the rhizosphere bacteria Bacillus halotolerans NYG5 isolate comprises at least 99% of the total weight of the composition.

In certain embodiments, the composition further comprises at least one volatile organic compound selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10).

In certain embodiments, the composition further comprises C1. In certain embodiments, the composition further comprises C2. In certain embodiments, the composition further comprises C3. In certain embodiments, the composition further comprises C7. In certain embodiments, the composition further comprises C10.

In certain embodiments, the composition comprises C1 and at least one different volatile organic compound selected from the group consisting of C2, C3, C7 and C10. In certain embodiments, the composition comprises C2 and at least one different volatile organic compound selected from the group consisting of C1, C3, C7 and C10. In certain embodiments, the composition comprises C3 and at least one different volatile organic compound selected from the group consisting of C1, C2, C7 and C10. In certain embodiments, the composition comprises C7 and at least one different volatile organic compound selected from the group consisting of C1, C2, C3 and C10. In certain embodiments, the composition comprises C10 and at least one different volatile organic compound selected from the group consisting of C1, C2, C3 and C7.

In certain embodiments, the composition comprises rhizosphere bacteria Bacillus halotolerans NYG5 isolate, C1, and C2. In certain embodiments, the composition comprises rhizosphere bacteria Bacillus halotolerans NYG5 isolate, C1, and C3. In certain embodiments, the composition comprises rhizosphere bacteria Bacillus halotolerans NYG5 isolate, C1, and C7. In certain embodiments, the composition comprises rhizosphere bacteria Bacillus halotolerans NYG5 isolate, C1, and C10.

In certain embodiments, the composition comprises rhizosphere bacteria Bacillus halotolerans NYG5 isolate, C2, and C3. In certain embodiments, the composition comprises rhizosphere bacteria Bacillus halotolerans NYG5 isolate, C2, and C7. In certain embodiments, the composition comprises rhizosphere bacteria Bacillus halotolerans NYG5 isolate, C2, and C10.

In certain embodiments, the composition comprises rhizosphere bacteria Bacillus halotolerans NYG5 isolate, C3, and C7. In certain embodiments, the composition comprises rhizosphere bacteria Bacillus halotolerans NYG5 isolate, C3, and C10.

In certain embodiments, the composition comprises rhizosphere bacteria Bacillus halotolerans NYG5 isolate, C7, and C10.

In certain embodiments, the composition comprises rhizosphere bacteria Bacillus halotolerans NYG5 isolate, C1, C2, C3, C7 and C10.

In certain embodiments, the composition comprises an antifungal agent. In certain embodiments, the composition comprises an antibacterial agent. In certain embodiments, the composition comprises a nematicidal agent. In certain embodiments, the composition comprises a fertilizer.

As used herein, the term “fertilizer” is intended to mean any product used in agriculture and/or gardening with the aim of creating, reconstituting, conserving or increasing a fertility of a terrain, giving the terrain one or more nutritional elements usable by plants. The term “fertilizer” comprises manure, soil amendments and/or corrective substances.

The disclosure provides, in another aspect, a method for preventing or treating a disease of a plant, or for improving the growth of a plant, comprising the step of applying a composition comprising rhizosphere bacteria Bacillus halotolerans NYG5 isolate or at least one volatile organic compound selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10), to the plant.

In certain embodiments, the method is for preventing or treating a disease of a plant.

In certain embodiments, the method is for improving the growth of a plant.

In certain embodiments, the method is for preventing or treating a disease of a plant and for improving the growth of a plant.

In certain embodiments, the composition comprises rhizosphere bacteria Bacillus halotolerans NYG5 isolate.

In certain embodiments, the composition comprises C1, C2, C3, C7, or C10.

In certain embodiments, the composition comprises at least two different volatile organic compounds selected from the group consisting of C1, C2, C3, C7 and C10.

In certain embodiments, the composition comprises rhizosphere bacteria Bacillus halotolerans NYG5 isolate and at least one volatile organic compound selected from the group consisting of C1, C2, C3, C7 and C10.

In certain embodiments, the composition comprises rhizosphere bacteria Bacillus halotolerans NYG5 isolate and C1. In certain embodiments, the composition comprises rhizosphere bacteria Bacillus halotolerans NYG5 isolate and C2. In certain embodiments, the composition comprises rhizosphere bacteria Bacillus halotolerans NYG5 isolate and C3. In certain embodiments, the composition comprises rhizosphere bacteria Bacillus halotolerans NYG5 isolate and C7. In certain embodiments, the composition comprises rhizosphere bacteria Bacillus halotolerans NYG5 isolate and C10.

In certain embodiments, the method comprises the step of applying the composition to the root, stem or leaves of the plant. In certain embodiments, the method comprises the step of applying the composition to the root of the plant. In certain embodiments, the method comprises the step of applying the composition to the stem of the plant. In certain embodiments, the method comprises the step of applying the composition to the leaves of the plant. In certain embodiments, the method comprises the step of applying the composition to the entire plant.

In certain embodiments, the infection is a fungal infection. In certain embodiments, the method further comprises the step of applying another antifungal agent to the plant.

As used herein, the term “antifungal agent” is intended to mean a substance capable of inhibiting or preventing the growth, viability and/or reproduction of a fungal cell. Antifungal agents are those capable of preventing or treating a fungal infection in a plant. In certain embodiments, an antifungal agent is a broad-spectrum antifungal agent. In certain embodiments, an antifungal agent is specific to one, or several, species of fungus.

In certain embodiments, the infection is a bacterial infection. In certain embodiments, the method further comprises the step of applying another antibacterial agent to the plant.

As used herein, the term “antibacterial agent” is intended to mean a substance having either a bactericidal or bacteriostatic effect upon bacteria contacted by the substance. As used herein, the term “bactericidal” is defined to mean having a destructive killing action upon bacteria. As used herein, the term “bacteriostatic” is defined to mean having an inhibiting action upon the growth of bacteria. In certain embodiments, an antibacterial agent is a broad-spectrum antibacterial agent. In certain embodiments, an antibacterial agent is specific to one, or several, species of bacteria.

In certain embodiments, the infection is a nematode infection. In certain embodiments, the method further comprises the step of applying another nematicidal agent to the plant.

As used herein, the term “nematicidal agent” is intended to mean a substance which increases mortality or inhibits the growth rate of nematodes. In certain embodiments, a nematicidal agent is a broad-spectrum nematicidal agent. In certain embodiments, a nematicidal agent is specific to one, or several, species of nematodes.

In certain embodiments, the plant is selected from the group consisting of vegetables, fruits, cereals, herbs, plant seeds, plant leaves, plant tubers, and ornamental plants. In certain embodiments, the plant is a vegetable. In certain embodiments, the plant is a fruit. In certain embodiments, the plant is a cereal. In certain embodiments, the plant is an herb. In certain embodiments, the plant is a seed of a plant. In certain embodiments, the plant is a leaf of a plant. In certain embodiments, the plant is a tuber of a plant. In certain embodiments, the plant is an ornamental plant.

In certain embodiments, the composition is applied to the plant before the plant is harvested. In certain embodiments, the composition is applied to the plant while the plant is harvested. In certain embodiments, the composition is applied to the plant after the plant is harvested.

The present disclosure provides, in another aspect, a transgenic cell, which produces at least one volatile organic compound selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10).

In certain embodiments, at least one gene involved in producing C1, C2, C3, C7, or C10 is comprised in the chromosome of the transgenic cell. In certain embodiments, at least one gene involved in producing C1, C2, C3, C7, or C10 is not comprised in the chromosome of the transgenic cell. In certain embodiments, at least one gene involved in producing C1, C2, C3, C7, or C10 is comprised in a non-chromosomal DNA construct of the transgenic cell.

In certain embodiments, the transgenic cell produces at least two different volatile organic compounds selected from the group consisting of C1, C2, C3, C7 and C10.

In certain embodiments, the transgenic cell produces C1 and C2. In certain embodiments, the transgenic cell produces C1 and C3. In certain embodiments, the transgenic cell produces C1 and C7. In certain embodiments, the transgenic cell produces C1 and C10.

In certain embodiments, the transgenic cell produces C2 and C3. In certain embodiments, the transgenic cell produces C2 and C7. In certain embodiments, the transgenic cell produces C2 and C10.

In certain embodiments, the transgenic cell produces C3 and C7. In certain embodiments, the transgenic cell produces C3 and C10.

In certain embodiments, the transgenic cell produces C7 and C10.

In certain embodiments, the transgenic cell produces C1 and at least one different volatile organic compound selected from the group consisting of C2, C3, C7 and C10. In certain embodiments, the transgenic cell produces C2 and at least one different volatile organic compound selected from the group consisting of C1, C3, C7 and C10. In certain embodiments, the transgenic cell produces C3 and at least one different volatile organic compound selected from the group consisting of C1, C2, C7 and C10. In certain embodiments, the transgenic cell produces C7 and at least one different volatile organic compound selected from the group consisting of C1, C2, C3 and C10. In certain embodiments, the transgenic cell produces C10 and at least one different volatile organic compound selected from the group consisting of C1, C2, C3 and C7.

In certain embodiments, the transgenic cell produces C1, C2, C3, C7 and C10.

In certain embodiments, the transgenic cell is a bacteria cell. In certain embodiments, the transgenic cell is a yeast cell. In certain embodiments, the transgenic cell is a human cell.

In certain embodiments, the transgenic cell is not a bacteria cell. In certain embodiments, the transgenic cell is not a Bacillus bacteria cell. In certain embodiments, the transgenic cell is not a Bacillus halotolerans bacteria cell.

The disclosure provides, in another aspect, a plant, or any part thereof, at least partly in contact with rhizosphere bacteria Bacillus halotolerans NYG5 isolate or with at least one volatile organic compound selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10).

In certain embodiments, there is provided a plant or a part thereof at least partly in contact with rhizosphere bacteria Bacillus halotolerans NYG5 isolate.

In certain embodiments, there is provided a plant or a part thereof at least partly in contact with C1, C2, C3, C7, or C10.

The disclosure provides, in another aspect, a method of fumigating a growing medium for plants, comprising applying a composition comprising rhizosphere bacteria Bacillus halotolerans NYG5 isolate or at least one volatile organic compound selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10), to the growing medium.

In certain embodiments, the method comprises applying a composition comprising rhizosphere bacteria Bacillus halotolerans NYG5 isolate to the growing medium.

In certain embodiments, the method comprises applying a composition comprising C1, C2, C3, C7, or C10 to the growing medium.

The disclosure provides, in another aspect, a growing medium for plants, at least partly in contact with rhizosphere bacteria Bacillus halotolerans NYG5 isolate or with at least one volatile organic compound selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10).

The term “growing medium” as used herein refers to a medium in which, or on which, plants, or roots of plants, grow. The term “growing medium” includes, but is not limited to, naturally occurring or artificially amended soils used in agriculture, horticulture and hydroponics.

In certain embodiments, there is provided a growing medium for plants at least partly in contact with rhizosphere bacteria Bacillus halotolerans NYG5 isolate.

In certain embodiments, there is provided a growing medium for plants at least partly in contact with C1, C2, C3, C7, or C10.

The disclosure provides, in another aspect, a dispenser, comprising a container comprising rhizosphere bacteria Bacillus halotolerans NYG5 isolate or at least one volatile organic compound selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10).

As used herein, the term “dispenser” refers to a product including a container containing a quantity of material, the quantity typically sufficient for several repeated applications of the material.

In certain embodiments, the container comprises rhizosphere bacteria Bacillus halotolerans NYG5 isolate.

In certain embodiments, the container comprises C1, C2, C3, C7, or C10.

In certain embodiments, the rhizosphere bacteria Bacillus halotolerans NYG5 isolate, C1, C2, C3, C7, or C10 are formulated as or within a solid.

In certain embodiments, the rhizosphere bacteria Bacillus halotolerans NYG5 isolate, C1, C2, C3, C7, or C10 are formulated as or within a liquid.

In certain embodiments, the rhizosphere bacteria Bacillus halotolerans NYG5 isolate, C1, C2, C3, C7, or C10 are formulated as or within an aerosol.

### EXAMPLES

Material and Methods

Bacterial and fungal strains growth conditions. The bacterial strain is a pure isolate from rhizosphere soil of Israel. The bacterial culture was grown on Luria Bertani (LB) agar medium and modified Nitrate Minimal medium (NMM) consists of sodium nitrate (6 g), potassium dihydrogen phosphate (1.5 g/1), potassium chloride (0.52 g), magnesium sulphate (0.25 g), glucose (10 g), Hutner's trace element (1 ml), agar-agar (1.5) and distilled water (1000 ml). The culture was maintained in glycerol stock at −80° C. Bacteria strain was grown on LB agar medium and NMM at 28±2° C. Fungal strains were collected from plant pathology department, Volcani Research Center (ARO), Israel. The fungal strains were maintained on potato dextrose agar (PDA) medium at 25° C.

In-vitro antagonistic activity of volatiles produced by NYG5. The efficacy of the volatiles produced by NYG5 on mycelium and colony growth of tested pathogens was analyzed in a two-compartment plate so that only the volatiles can transfer from one side to another side. To test on fungal pathogens NYG5 strain was streaked on half of the portion of two compartment plate on LB Agar medium while another half was poured with PDA medium before bacterial inoculation. The petri plate was double sealed with parafilm and kept at 28° C. for 72 hrs. After 72 hours a 2 mm bit of freshly grown mycelium plug was placed on another half of the plate, containing PDA medium and plate was resealed. The radial growth of fungal mycelium was measured up to 3 days and compare with the control plate to measure percent mycelium growth inhibition. Similar procedure was used to test NYG5 against bacterial pathogens by replacing the PDA medium in one compartment with LB medium. For tested bacterial pathogen, 100 μl of growth suspension (10⁶ CFU/ml) was spread in one compartment of the petri plate and CFU were count after 24 hours growth. The percent inhibition in growth was calculated to compare the growth colonies with the relative control. The experiment was repeated thrice having three individual replicates.

In-vitro assay for Sclerotia viability. To evaluate the effect of NYG5 produced volatiles same two compartment petri plates were used to check the inhibition of sclerotia. Sclerotinia sclerotiorum was grown on PDA medium and fresh sclerotia were collected for the experiment. The bacteria were streaked on one half the compartment on LB medium and uniform size sclerotia were kept in the other empty half of the petri plate. The plates were sealed with parafilm and incubate at 28° C. up to 5 days including control without any bacterial growth. The sclerotia were transferred on fresh PDA plate after 1, 3 and 5 days of bacterial volatile exposure. Mycelial germination of volatile treated and untreated sclerotia were measured after 1, 3 and 5 days and percent germination was calculated by compare the mean value of germinated sclerotia from control and treatment. Each treatment has five individual replicates and each replicate have 10 sclerotia.

Identification of NYG5 derived volatile organic compounds through GCMS. NYG5 was grown in 200 ml glass bottles containing LB medium in slant shape and the bottles were tightly sealed with cap having a soft rubber cork in the center. The culture was grown up to 3 days to collect the volatiles according the timing of in-vitro test to kill the fungus and other pathogens. Volatiles were collected through 50/30 μm, 1 cm SPME fiber (Supelco Inc) coated with Divinylbenzene/Carboxen/Polydimethylsiloxane (DVB/CAR/PDMS). Culture bottles were heated up to 50° C. for 20 min before collecting the volatiles to make equilibrium inside the bottles for gases. After maintaining the equilibrium SPME fiber was inserted through the cork inside the bottle and was exposed to the headspace for 30 min at 50° C. After 30 min volatile absorption, SPME fiber was directly inserted into GAS Chromatography coupled with Mass spectrometry (GC-MS Agilent 6890/5977A) for volatile desorption and detection. The volatiles were desorbed at 240° C. (2 min) in injector with split 1:2 and separated on Agilent 30 m×0.25 mm i.d. HP-5MS UI column (5% Phenyl/Methylpolysiloxane, 0.25 μm film thickness). The initial oven temperature was 40° C. for 1 min, increased to 250° C. (15° C./min), further increased to 300° C. (30° C./min) and held for 5 min. The mass spectrometer was operated in the electron ionization mode at 70 eV at 250° C. with a scan from 40 to 500 m/z. The mass spectra of VOCs were corroborated with NIST/EPA/NIH mass spectrometry library with respect to the spectra in the Mainlib and/or Replib databases.

Antifungal activity of synthetic VOCs. The GC-MS identified VOCs produced by NYG5 were screened through literature for their any biological activity and the novel compound which were not tested so far were purchased as pure standard compound of the most representative VOCs from Hollan Moran Ltd., Israel. The pure synthetic compounds were tested against four different fungal pathogens (Macrophomina phaseolina, Rhizoctonia solani, Pythium aphanidermatum and Sclerotinia sclerotiorum) with different concentrations (0.005, 0.05. 0.5 ppm) in small plastic petri plates. A freshly growing mycelial agar bid (4 mm) were placed in the center of PDA medium and one sterile paper disc (10 mm) were kept on the lid of the plate. After fungal inoculation, the tested compounds (10 μl for each) were placed on sterile filter disc and plates were double sealed with parafilm in inverted position having mycelium disc on the top side of the plate to check the direct effect of volatiles on mycelial growth. Three individual replicates were maintained for each treatment including control having sterile filter disc and solvent (70% ethanol) in which compounds were diluted. The concentration of pure compounds introduced in the petri dishes corresponded to 0.005, 0.05, and 0.5 ppm (part per million/ml of empty head space of petri plate). The plates were incubated at 25° C. and radial growth of fungal mycelial was measured at day interval until 3 days. The mean value of three individual replicates were analyze and compare with control to present mycelium growth inhibition.

Effect of 2, 3-Hexanedione (C3) on fungal spores in liquid. To test the effect of C3 on spore germination, fungal spores were harvested after 3 days growth of Fusarium oxysporum in Potato Dextrose Broth medium with continuous shaking at 25° C. To collect the spores, 3 days old grown mycelial in broth medium was filtered through sterilized glass wools and filtrate was centrifuged at 4000 rpm. The supernatant was discarded, and pellet was suspended in sterilized water to a dilution of 10⁶ (spores/ml) and counted through hemocytometer. Spore inhibition test was performed in 1.5 ml Eppendorf tube having 100 μl of 5×10⁵ spores and mixed with a final concentration of 1 ppm, 10 ppm and 100 ppm of C3 compound. The tubes were tightly closed and sealed with parafilm and incubated at 25° C. Spore germination was observed under compound microscope by placing 20 μl of solution droplet from control and treatment on glass slide. The germination was reconfirmed by growing the 20 μl of solution from tube on PDA simultaneously to check the mycelial growth. All experiments had three individual replicates and repeated twice having identical conditions.

In-vitro nematicidal activity of 2, 3-Hexanedione (C3). Nematicidal efficacy of 2,3-Hexanedione had been tested against Meloidogyne javanica larvae. M. javanica eggs were extracted from the infected root of tomato Lycopersicon esculentum using standard protocol. The experiment was set up in a two-compartment plate to test the nematicidal activity of C3 compound against M. javanica larvae. One small glass vial was placed in one-half of compartment having 300 M. javanica larvae in 1000 of 0.001 M IVIES and sterile filter disc were kept in another compartment. The discs were spot with 10 μl of different concentration (0.05 and 0.5 ppm) of C3 compound and double sealed with parafilm. Each treatment had three independent replicates with control (without any compound only sterile disc). After 2 days of incubation M. javanica were carefully washed through 30 μm sieve and allowed to pass the sieve for 3 hours. All incubations were performed in the dark at 25±1° C. Survived M. javanica were counted under microscope.

Experimental set up for evaluation of 2,3-Hexanedione (C3) effect on Arabidopsis thaliana. Plant material and seed germination. A. thaliana (Ecotype Col-1) seeds were obtained from ARO Volcani center. The seeds were surface sterilized thrice with sterile distilled water and kept at 4° C. till 48 hours for stratification in dark on moist filter paper in petri plate. After two days of stratification the seeds were placed for germination on Murashige and Skoog (MS) medium with vitamins, 3% sucrose (30 g/1), and 0.03% phytagel (pH 5.7) for 3 days at 23° C.

Effect of 2,3-Hexanedione (C3) on A. thaliana growth. Effect of 2,3-Hexanedione on A. thaliana development was evaluated in-vitro conditions in a two-compartment plate assay. Uniformly germinated seeds (5) were transplanted on MS medium in one side of compartment plate and another compartment was used to place the tested compound C3 similarly with other experiments. Different concentration (0.05, 0.5 ppm) of C3 compound were placed on the sterile filter disc and plates were sealed with parafilm. The control plants were maintained without any compound in two compartment petri plates. The plants were grown under 14-hour day/10-hour night cycles at 23° C. for 2 weeks and growth parameters were observed.

Effect of 2,3-Hexanedione (C3) on PR gene expression in A. thaliana. An individual experiment was designed similarly as described above to check the effect of 2,3-Hexanedione on PR gene induction in A. thaliana. The plants were exposed with 2,3-Hexanedione in a two compartment plates for one week. After one week, leaves from individual plants of each replicate were pooled separately for RNA isolation. Total RNA was isolated from the leaf tissue of plant using RNA isolation kit (Nucleo spin RNA Plant, MACHEREY-NAGEL) according the manufacturer's instruction. Before starting the protocol, leaves were ground under liquid N2 and 100 mg of grinded tissue was used for RNA isolation. RNA quantification was done using Qubit analyzer. Purified RNA was used for cDNA synthesis using first strand Invitrogen cDNA synthesis kit according the manufacturer's instructions with 1 mg of RNA. Synthesized cDNA was diluted to 1000 times and 10 ul aliquots were stored for gene expression analysis. The relative gene expression level of PR1, PR2, PR5 and Actin (as internal control) were quantified for C3 exposed and control plants. For qRT PCR a 20 ul reaction was programmed at 95° C. denaturation for 1 min, followed by 40 cycles of amplification at 95° C. for 5s, 60° C. for 30s, and 72° C. for 30s.

### Example 1. In-Vitro Antagonistic Activity of Volatiles Produced by NYG5

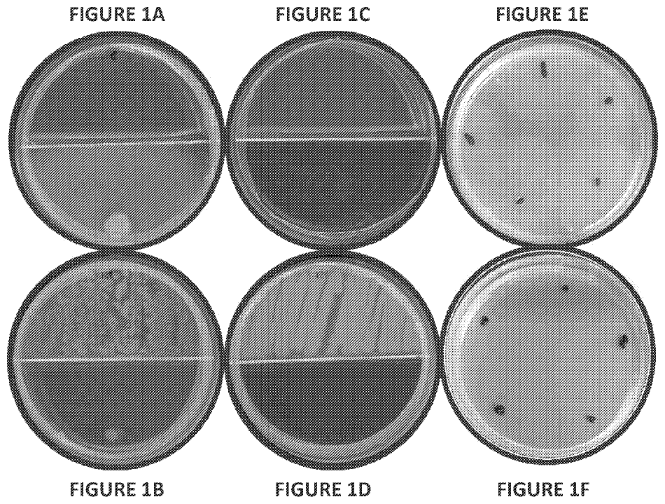

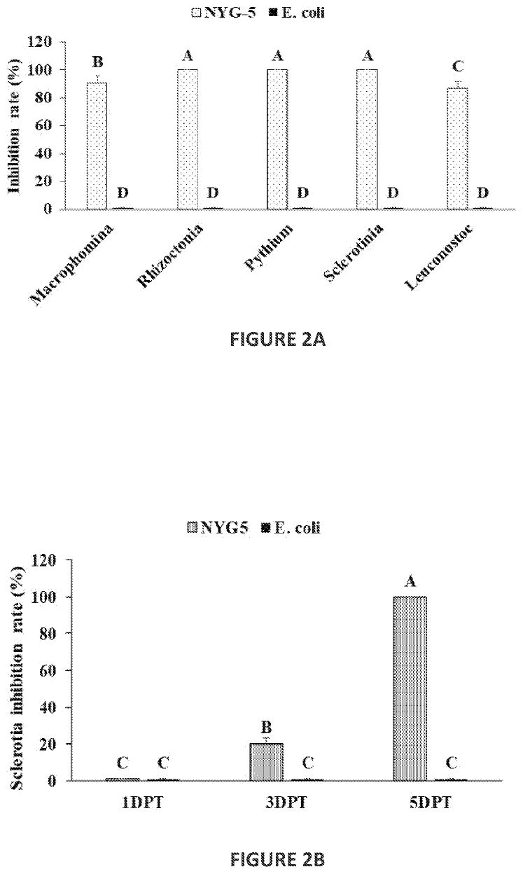

The antagonistic effect of volatiles produced by NYG5 was tested against pathogens Macrophomina phaseolina, Rhizoctonia solani, Pythium aphanidermatum, Sclerotinia sclerotiorum and Leuconostoc mesenteroides in a two-compartment plate assay (FIG. 1A-FIG. 1F, Table 2). The volatiles showed antagonistic effect on the growth of the tested fungal pathogen in petri plates pre-exposed to NYG5 for 3 days. The volatiles showed 100% mycelial growth inhibitory effect on all tested fungal pathogens except M. phaseolina (80% inhibition) as well as L. mesenteroides (FIG. 2A). Interestingly, NYG5 had also showed antagonistic effect while growing on nitrate minimal medium but higher effect was observed on LB medium growth. The volatiles effect was lethal, and no mycelium growth was observed on the plates for at least 5-7 days.

TABLE 2
Classification and host rage of tested plant pathogenic fungi.

| | | | | | | Diseases |
|---|---|---|---|---|---|---|
| Fungi | Division | Class | Order | Family | Host Range | severity |
| Sclerotinia | Ascomycota | Leotiomycetes | Helotiales | Sclerotiniaceae | Tobacco, | Sporadic, |
| sclerotiorum | | | | | vegetables, oil | cause |
| | | | | | seeds and | severe |
| | | | | | ornamentals, | damage |
| | | | | | around 400 plant | |
| | | | | | species and 64 | |
| | | | | | families | |
| Pythium | Oomycota | Oomycetes | Pythiales | Pythiaceae | Wide host range, | Sporadic, |
| aphanidermatum | | | | | soybeans, beets, | cause |
| | | | | | peppers, | severe |
| | | | | | chrysanthemum, | damage |
| | | | | | cucurbits, cotton | |
| | | | | | and turf-grasses | |
| Macrophomina | Ascomycota | Dothideomycetes | Botryosphaeriales | Botryosphaeri aceae | ~500 plant species | Sporadic, |
| phaseolina | | | | | and 100 families; | cause |
| | | | | | peanut, cabbage, | severe |
| | | | | | pepper, chickpea, | damage |
| | | | | | soybean, | |
| | | | | | sunflower, sweet | |
| | | | | | potato, alfalfa, | |
| | | | | | sesame, potato, | |
| | | | | | sorghum, wheat, | |
| | | | | | and corn, | |
| Rhizoctonia solani | Basidiomycota | Agaricomycetes | Cantharellales | Ceratobasidiaceae | Soybean, cereal, | Sporadic, |
| | | | | | sugar beet, | cause |
| | | | | | cucumber, rice, ~24 | severe |
| | | | | | families and 200 | damage |
| | | | | | plant species | |
| Fusarium | Ascomycota | Sordariomycetes | Hypocreales | Nectriaceae | Cause panama | Sporadic, |
| oxysporum f. sp. | | | | | diseases in wide | cause |
| cubense | | | | | range of banana | severe |
| | | | | | cultivars | damage |

### Example 2. Effect of NYG5 Derived Volatiles on Sclerotia Viability

Germination efficiency of Sclerotia from Sclerotinia sclerotiorum was tested in-vitro in a two-compartment plate assay. Sclerotia exposed to NYG5-produced volatiles lost viability after 5 days of exposure. The VOCs-treated sclerotia stop germination on PDA agar medium after 5 days of continuous exposure, showed 20% inhibition on sclerotia germination after 3 days exposure, and had no effect on germination after one day of exposure. The results show the fungicide effect of volatiles on sclerotia viability (FIG. 2B).

### Example 3. Identification of NYG5 Derived Volatile Organic Compounds

A qualitative head space analysis of SPME collected VOCs produced by NYG5 in two different media (LB and nitrate Minimal medium) indicated the presence of diversity of VOC and different compounds in individual medium. The majority of compounds were detected after 3 days of incubation, and there was no significant difference afterwards until a five-day measurement. The majority of volatiles were ketones, and other volatiles were hydrocarbon, alcohols, and esters. Solid phase microextraction (SPME) absorbed volatile organic compounds were identified based on their mass and time of flight.

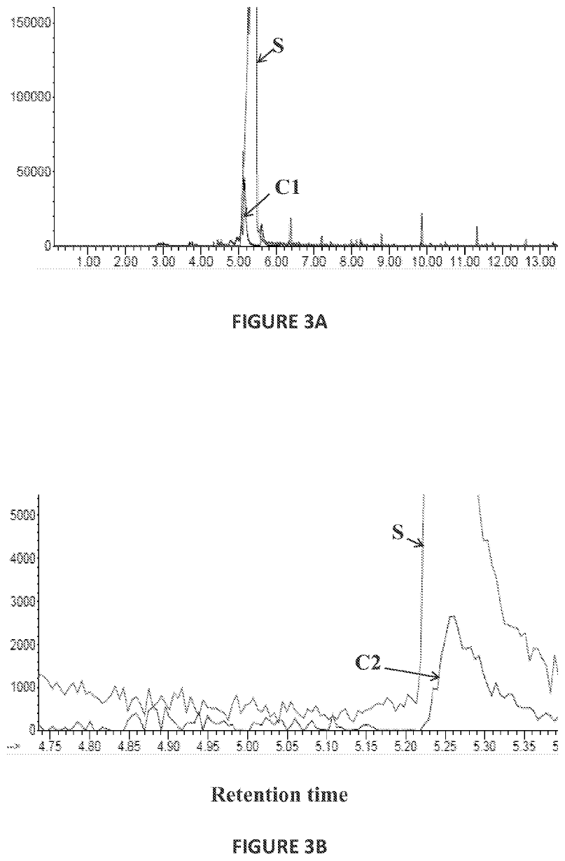

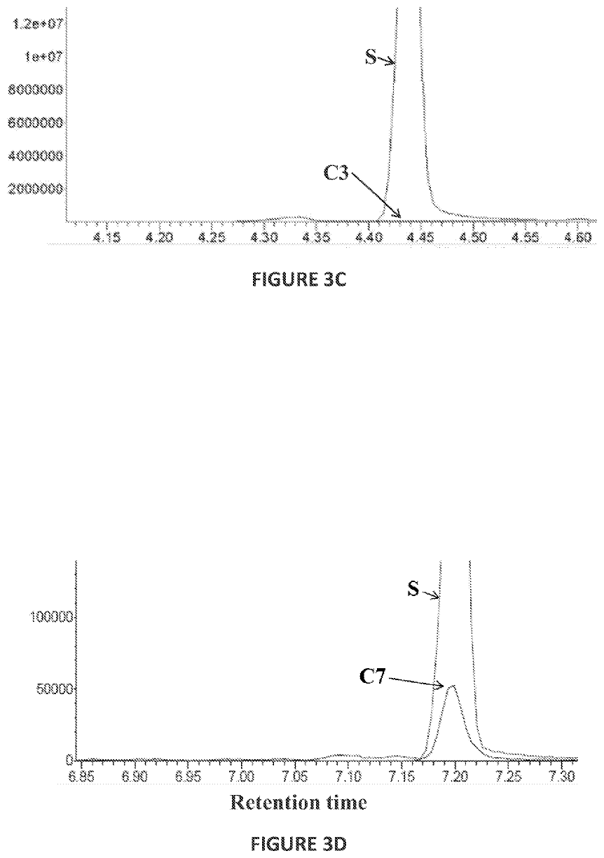

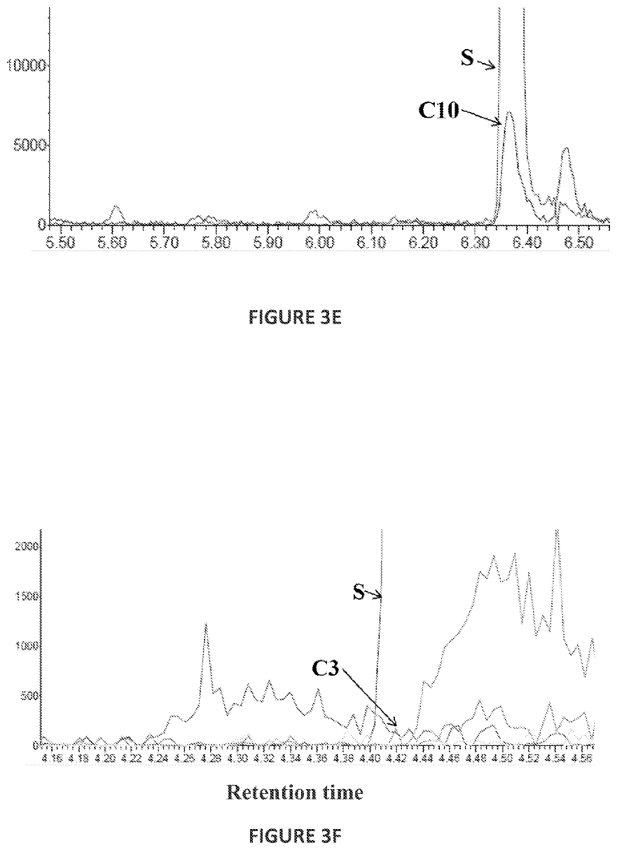

Of which, five compounds (C1—Butanoic acid, 2-methyl, C2—5-Methyl-2-hexanone, C3—2,3-Hexanedione, C7—1-Hexanol, 2-ethyl and C10—Methyl-2-heptanone) were not previously reported for any biological activity (Table 3). The identity of the selected volatile organic compounds was confirmed with standard compounds through GCMS based on their retention time and molecular mass (FIG. 3A-FIG. 3F). The detection of C3 compound was lowest as shown the red peak close to baseline (FIG. 3C). To confirm the presence of all compounds the experiment was repeated thrice, and same peaks were observed in every repeat.

TABLE 3
Identification of volatile organic compounds produced by NYG5
through GCMS.

| | | | Retention |
|---|---|---|---|
| Compound | Volatile organic compounds | *CAS No. | Time |
| C1 | Butanoic acid, 2-methyl- | 116-53-0 | 5.25 |
| C2 | 5 -Methyl-2-hexanone | 110-12-3 | 5.27 |
| C3 | 2,3-Hexanedione | 3848-24-6 | 4.42 |
| C7 | 1-Hexanol, 2-ethyl- | 104-76-7 | 7.19 |
| C10 | 6-Methyl-2-heptanone | 928-68-7 | 6.37 |

*Unique numerical identifier assigned by the Chemical Abstracts Service.

It was further found that the ratio between C1:C2:C3:C7:C10 based on peak area is about 5:17:9:40:29, and that the ratio between C1:C2:C3:C7:C10 based on molecular mass is about 17:19:19:22:22.

### Example 4. Antifungal Activity of Synthetic VOCs

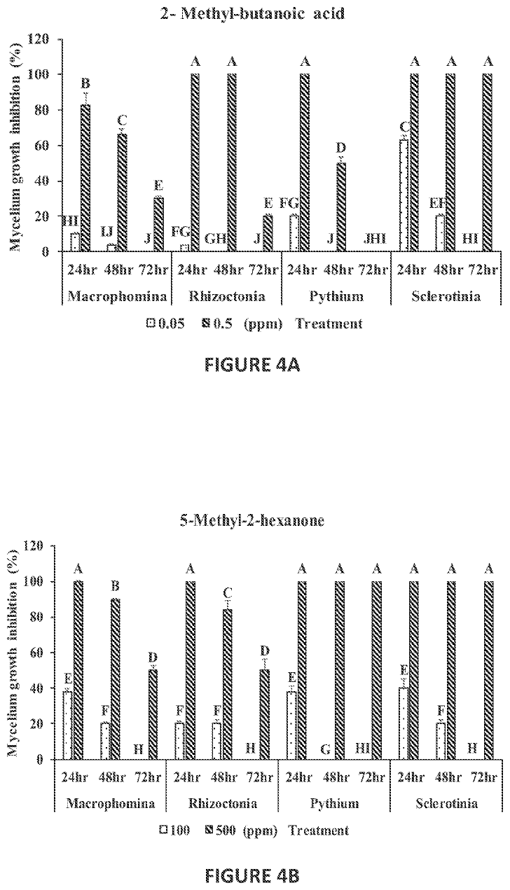

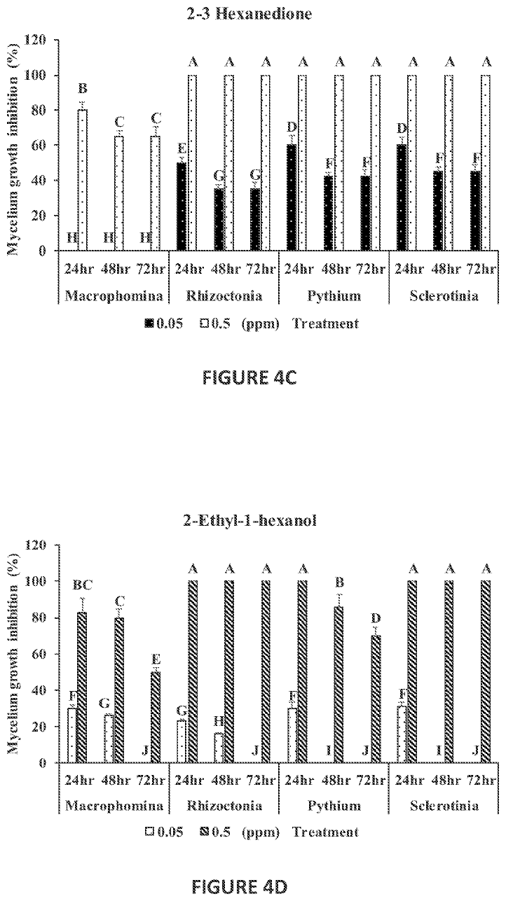

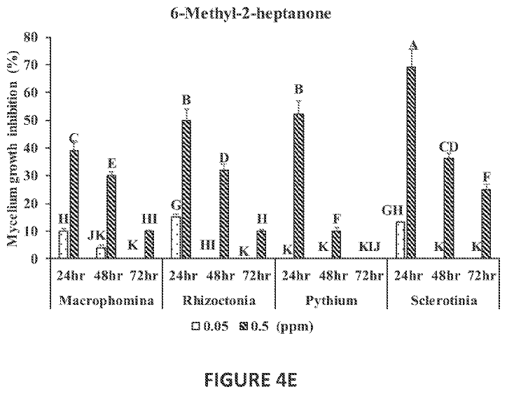

The 5 selected volatile organic compounds were tested for antagonistic activity in a plate assay. The pure VOCs showed antifungal activity against four different fungal pathogens (Macrophomina phaseolina, Rhizoctonia solani, Pythium aphanidermatum and Sclerotinia sclerotiorum). The tested compounds showed 100% inhibitory effect on mycelial growth of fungi. All the compounds, except 5-Methyl-2-hexanone (C2), showed 60-100% growth inhibition with two different concentrations, 0.05 and 0.5 ppm, while C2 had showed inhibitory effect at higher concentrations, 100 and 500 ppm (FIG. 4A-FIG. 4E). The effect of 2,3-Hexanedione was strongest among all tested compounds and was lethal at 0.5 ppm (FIG. 4C). Volatile exposure of 2,3-Hexanedione showed fungicidal effect on all tested fungal pathogens.

### Example 5. Inhibition of Spore Germination in Liquid by 2,3-Hexanedione (C3)

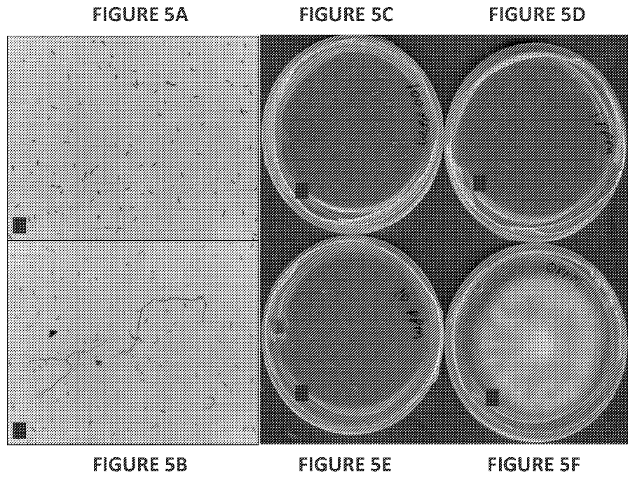

Fusarium spores treated with C3 did not show any germ tube while observed under microscope, and no growth was observed on PDA plates (FIG. 5A, FIG. 5B). The control spores started germination after 6 hours of incubation, but there was no germination of spores in the 1 ppm C3 compound treatment at least for 3 days. C3-treated spores were tested for germination on PDA medium, but no growth was observed on the plate (FIG. 5C, FIG. 5D, FIG. 5E). It proves that C3-treated spores completely lose their viability. Untreated spores grow well (FIG. 5F).

C3 has also been tested against Fusarium oxysporum f sp. Cubense. This fungus cause panama disease in wide range of banana cultivars. C3 had shown inhibitory effect against this fungus at 50 ppm and lethal effect at 200 ppm in-vitro.

### Example 6. Effect of C3 on Fungal Morphology

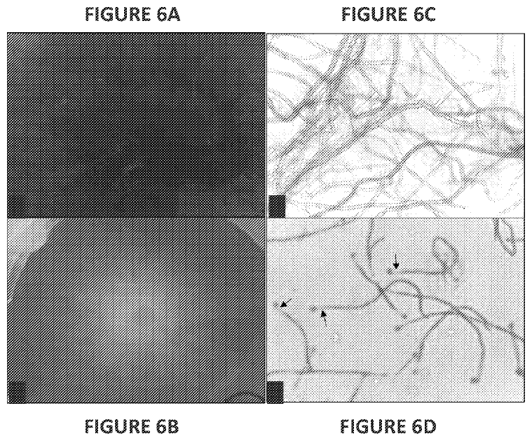

Actively-growing fungal mycelia, exposed with C3, showed mycelium growth inhibition and black-to-white discoloration of Macrophomina, while growing as observed in plate assay (FIG. 6A, FIG. 6B). Short fragment of mycelium was observed in C3-exposed fungi and longer and thicker with trypan blue staining under compound microscope was noticed in control mycelium (FIG. 6C, FIG. 6D). Effect of C3 on deformation of mycelial growth and protoplasm retraction was also observed under microscope. These results show the inhibitory effect of C3 on actively growing fungal mycelium by retarding mycelium growth, causing deformation of mycelia.

### Example 7. Effect of C3 on M. javanica Larval Viability

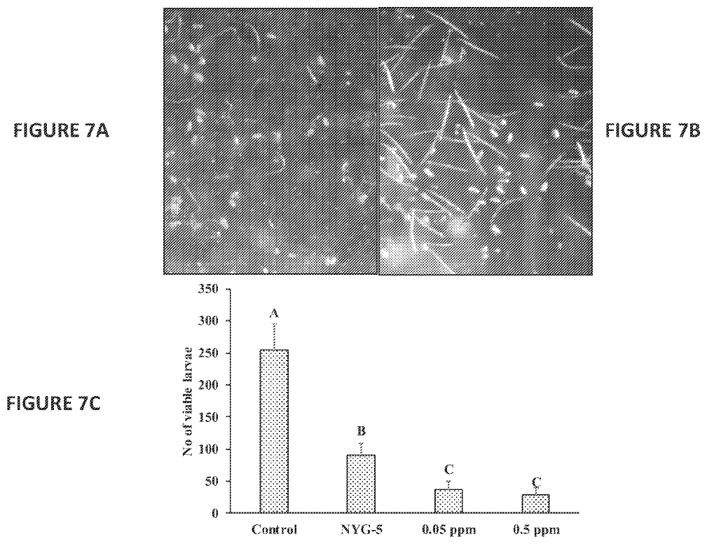

The nematicidal activity of C3 was tested in a two-compartment plate assay without any direct contact, as only the volatile can diffuse in air. C3 showed 80% nematicidal activity on M. javanica larvae with a concentration of 0.5 ppm, compared to survived larvae in the control (FIG. 7A-FIG. 7C). The lower concentration (0.05 ppm) of the compound also significantly reduced larval viability. C3 had shown strong nematicidal activity on the M. javanica larvae tested.

### Example 8. Effect of 2,3-Hexanedione (C3) on Arabidopsis Growth

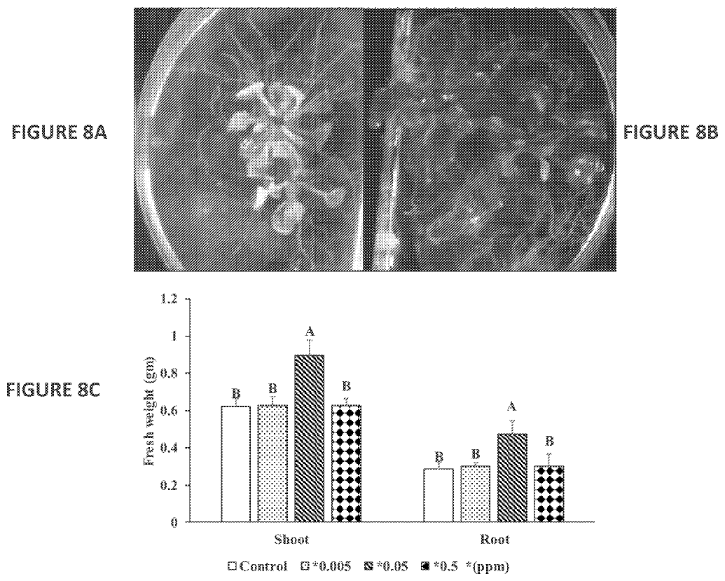

The plant growth promoting potential of C3 as volatile was examined by growing plants in partition plates with C3 exposure for 2 weeks. Seedling exposed to C3 exhibited both positive and neutral response with different concentration on Arabidopsis growth. Exposure of 0.05 ppm of C3 enhanced the growth of Arabidopsis plant after 2 weeks of exposure, while 0.005 ppm and 0.5 ppm concentration did not show any effect on plant growth parameters (FIG. 8A-FIG. 8C). A significant increase up to 2.5-fold was observed in plant fresh shoot and root weight as compare to control with 0.05 ppm exposure of C3 compound.

### Example 9. 2,3-Hexanedione (C3)-Mediated Induced PR Genes

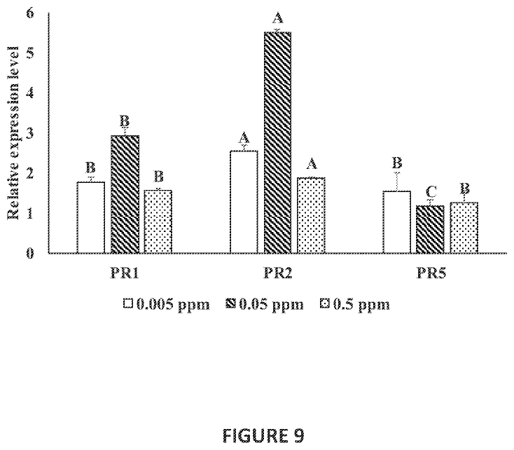

To check the effect of C3 on plant resistance, the expression level of defense-related PR genes was evaluated through qRT-PCR after 7 days of exposure. C3 has shown direct induction effect on jasmonic acid (JA)- and salicylic acid (SA)-responsive PR1 and PR2 gene. A 3-fold induction of PR1 gene and 5-fold upregulation of PR2 gene transcript was measured, without any direct contact of C3, while no significant difference was measured for PR5 at transcriptional level (FIG. 9). Interestingly, most significant difference was measured with exposure of 0.05 ppm exposure of C3. The experiment was repeated twice, and similar results were observed.

### Example 10. The Effect of NYG5 on Cucumis sativus Growth

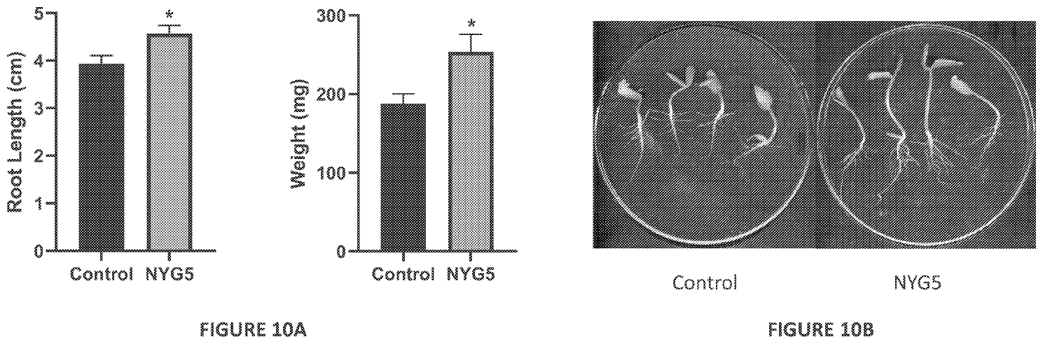

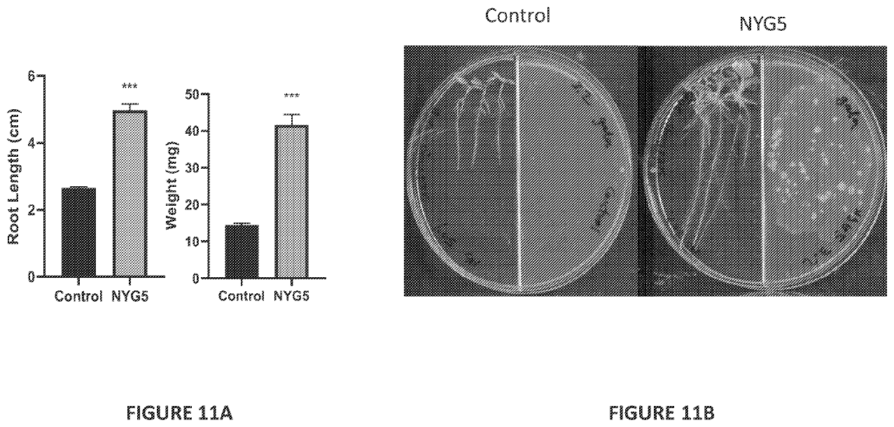

Seeds of C. sativus were placed on MS agar media in a two-compartment plate with NYG5 on the other half of the plate without direct contact between the compartments. In the control treatments, MS agar was used without bacteria. After 5 days of co-incubation, NYG5-treated plants had significantly longer primary roots and bigger plant biomass (FIG. 10A, FIG. 10B).

### Example 11. The Effect of NYG5 on Tobacco Seedlings Growth

7-days-old seedlings of N. tabacum were placed on MS agar media in a two-compartment plate with NYG5 on the other half of the plate without direct contact between the compartments. In the control treatments, MS agar was used without bacteria. After 14 days of co-incubation, NYG5 treated plants had significantly longer primary roots and bigger plant biomass (FIG. 11A, FIG. 11B).

### Example 12. The Effect of C3 on Tobacco Seedlings Growth

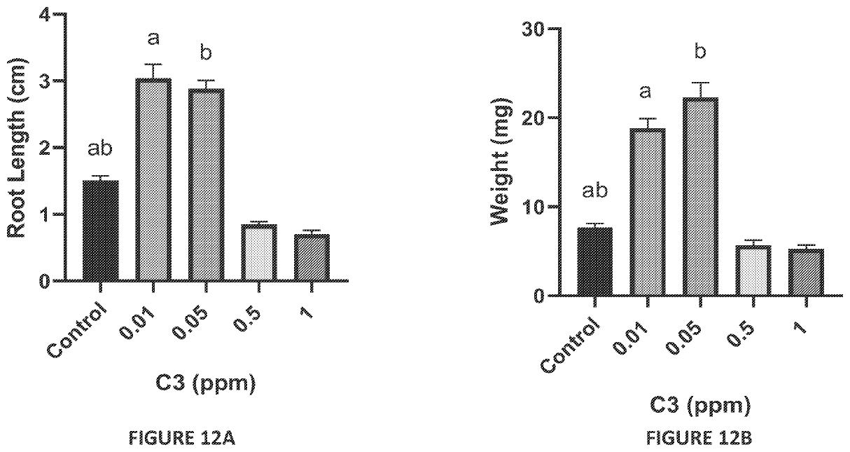

Seeds of N. tabacum were placed on MS agar media in a two-compartment plate with C3 in different concentrations on a sterile paper disk on the other half of the plate without direct contact between the compartments. In the control treatments, a sterile disk with ethanol was used. After 14 days of growth, N. tabacum treated with C3 at 0.01 and 0.05 ppm had significantly enhanced plant biomass and longer primary roots (FIG. 12A, FIG. 12B).

While certain features of the disclosure have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1-9. (canceled)

10. A composition comprising rhizosphere bacteria Bacillus halotolerans NYG5 isolate and at least one volatile organic compound selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10).

11. (canceled)

12. The composition of claim 10, comprising C3 and at least one different volatile organic compound selected from the group consisting of C1, C2, C7 and C10.

13. The composition of claim 12, comprising C1, C2, C3, C7 and C10.

14. The composition of claim 13, wherein the molar ratio between C1:C2:C3:C7:C10 is 5:17:9:40:29 or 17:19:19:22:22, respectively.

15. (canceled)

16. The composition of claim 10, comprising 0.05 ppm to 0.5 ppm of C1, 100 to 500 ppm of C2, 0.01 ppm to 0.5 ppm of C3, 0.05 ppm to 0.5 ppm of C7, or 0.05 ppm to 0.5 ppm of C10.

17-18. (canceled)

19. The composition of claim 10, further comprising an antifungal agent, an antibacterial agent, a nematicidal agent, a fertilizer, or any combination thereof.

20-22. (canceled)

23. A method for preventing or treating a disease of a plant, or for improving the growth of a plant, comprising the step of applying a composition comprising rhizosphere bacteria Bacillus halotolerans NYG5 isolate and at least one volatile organic compound selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10), to the plant.

24. (canceled)

25. The method of claim 23, wherein the composition comprises C3 and at least one different volatile organic compound selected from the group consisting of C1, C2, C7 and C10.

26. The method of claim 23, comprising C1, C2, C3, C7 and C10.

27. The method of claim 26, wherein the molar ratio between C1:C2:C3:C7:C10 is 5:17:9:40:29 or 17:19:19:22:22, respectively.

28. (canceled)

29. The method of claim 23, wherein the composition comprises 0.05 ppm to 0.5 ppm of C1, 100 to 500 ppm of C2, 0.01 ppm to 0.5 ppm of C3, 0.05 ppm to 0.5 ppm of C7, or 0.05 ppm to 0.5 ppm of C10.

30-32. (canceled)

33. The method of claim 23, comprising the step of applying the composition to the root, stem or leaves of the plant or to the entire plant.

34. (canceled)

35. The method of claim 23, wherein the infection is a fungal infection, a bacterial infection, or a nematode infection.

36. The method of claim 35, wherein the fungus is of a Division selected from the group consisting of Ascomycota, Oomycota, and Basidiomycota; wherein the fungus is of a Class selected from the group consisting of Leotiomycetes, Oomycetes, Dothideomycetes, Agaricomycetes, and Sordariomycetes; wherein the fungus is of an Order selected from the group consisting of Helotiales, Pythiales, Botryosphaeriales, Cantharellales, and Hypocreales; wherein the fungus is of a Family selected from the group consisting of Sclerotiniaceae, Pythiaceae, Botryosphaeriaceae, Ceratobasidiaceae, and Nectriaceae; or wherein the fungus is selected from the group consisting of Macrophomina phaseolina, Rhizoctonia solani, Pythium aphanidermatum, Sclerotinia sclerotiorum, and Fusarium oxysporum f. sp. Cubense; or
wherein the bacteria is Leuconostoc mesenteroides; or
wherein the nematode is Meloidogyne javanica.

37-46. (canceled)

47. The method of claim 23, wherein the method further comprises the step of applying a nematicidal agent, antifungal agent or antibacterial agent to the plant.

48. (canceled)

49. The method of claim 23, wherein the plant is selected from the group consisting of vegetables, fruits, cereals, herbs, plant seeds, plant leaves, plant tubers, and ornamental plants, and wherein the composition is applied to the plant before or after the plant is harvested.

50. (canceled)

51. The method of claim 23, wherein the plant is selected from the group consisting of Nicotiana tabacum, Cucumis sativus, and Arabidopsis thaliana.

52. A transgenic cell, which produces at least one volatile organic compound selected from the group consisting of Butanoic acid, 2-methyl (C1), 5-Methyl-2-hexanone (C2), 2,3-Hexanedione (C3), 1-Hexanol, 2-ethyl (C7) and Methyl-2-heptanone (C10).

53. (canceled)

54. The transgenic cell of claim 52, which produces C3 and at least one different volatile organic compound selected from the group consisting of C1, C2, C7 and C10.

55. (canceled)

56. The transgenic cell of claim 52, wherein the transgenic cell is a bacteria cell.

57-60. (canceled)
